(19) United States
(12) Patent Application Publication
(10) Pub. No.: US 2026/0278123 A1
(43) Pub. Date: Sep. 17, 2026

(54) Access Control Method and Device, and Program Deployment Method and Device

(71) Applicants: BEIJING BOE TECHNOLOGY DEVELOPMENT CO., LTD., Beijing (CN); BOE TECHNOLOGY GROUP CO., LTD., Chaoyang District, Beijing (CN)

(72) Inventors: Sicheng Lin, Beijing (CN); Xueqin Huang, Beijing (CN); Yanyang Hu, Beijing (CN); Yang Qiu, Beijing (CN); Yunlong Ding, Beijing (CN)

(21) Appl. No.: 18/996,395

(22) PCT Filed: May 15, 2024
(86) PCT No.: PCT/CN2024/093247

§ 371 Date: Jan. 17, 2025

(30) Foreign Application Priority Data
Jun. 7, 2023 (CN) 202310672787.5

(51) Int. Cl. G06F 21/60

(52) U.S. Cl. CPC G06F 21/604; G06F 21/602

(57) ABSTRACT

The present disclosure relates to the technical field of computers, and relates to an access control method and device, and a program deployment method and device. The access control method includes: receiving an access request initiated by a user for a subprogram by means of a main program; determining a determination result according to whether a first attribute of the access request is matched with a second attribute of the subprogram, wherein the second attribute is determined according to related information of a service corresponding to the subprogram; and if the determination result is that the first attribute is matched with the second attribute, allowing the user to access the subprogram.

### CROSS-REFERENCE TO RELATED APPLICATIONS

This application is the United States national phase of International Patent Application No. PCT/CN 2024/093247 filed May 15, 2024, and claims priority to Chinese Patent Application No. 202310672787.5 filed Jun. 7, 2023, the disclosures of which are hereby incorporated by reference in their entireties.

### BACKGROUND OF THE INVENTION

### Technical Field

The present disclosure relates to the technical field of computers, and in particular to an access control method, an access control device, a program deployment method, a program deployment device, an electronic device and a nonvolatile computer-readable storage medium.

### Description of Related Art

With the development of network technology and computing technology, a main program (such as a main application) can provide a service to a user through a plurality of subroutines (such as micro-applications). For example, based on the service of the micro-application open platform, a developer can package the micro-application and upload the micro-application to the platform.

In the process that the micro-application is launched and used, a system package, in the related art, comprises a plurality of subroutine modules; when the subroutine is launched, the registration of each subroutine of the related art is independent.

### SUMMARY OF THE INVENTION

According to some embodiments of the present disclosure, there is provided an access control method, comprising: receiving an access request for a subroutine initiated by a user through a main program; determining a judgment result according to whether a first attribute of the access request matches a second attribute of the subroutine, wherein the second attribute is determined according to relevant information of a service corresponding to the subroutine; and allowing the user to access the subroutine in response to the judgment result being a match.

In some embodiments, the first attribute comprises first access path information of one or more access pages of the access request, and the second attribute comprises second access path information of one or more associated pages.

In some embodiments, the first access path information comprises address information of each access page of the one or more access pages, and the second access path information comprises address information of each associated pages of the one or more associated pages.

In some embodiments, the one or more access pages comprise a plurality of access pages, the first access path information comprises routing information between each access page of the plurality of access pages, and the one or more associated pages comprise a plurality of associated pages, and the second access path information comprises routing information between each associated page of the plurality of associated pages.

In some embodiments, the relevant information comprises a requirement of the service, and an association relationship between the subroutine and the one or more associated pages is determined according to the requirement of the service.

In some embodiments, the service comprises a plurality of sub-services, and the relevant information comprises a processing order of the plurality of sub-services, and the routing information between each associated page of the plurality of associated pages is determined according to the processing order of the sub-services.

In some embodiments, determining a judgment result comprises: determining the judgment result according to whether the subroutine is an associated subroutine of the main program.

In some embodiments, an association relationship between the main program and the associated subroutine is determined according to a requirement of a service corresponding to the main program and a requirement of a service corresponding to the associated subroutine.

In some embodiments, the first attribute comprises a key of the access request, and the second attribute comprises a key of the subroutine.

In some embodiments, the first attribute comprises a key of the access request and first access path information of one or more access pages of the access request, and the second attribute comprises a key of the subroutine and second access path information of one or more associated pages of the subroutine, and determining a judgment result comprises: judging whether the subroutine is an associated subroutine of the main program; in response to the subroutine being the associated subroutine of the main program, judging whether the key of the access request matches the key of the subroutine; in response to the key of the access request matching the key of the subroutine, determining the judgment result according to whether the first access path information matches the second access path information.

In some embodiments, the subroutine is encapsulated according to the following steps: determining one or more associated pages of the subroutine according to the requirement of the service corresponding to the subroutine; configuring the second attribute for the subroutine according to the one or more associated pages; encapsulating the subroutine with the second attribute as a label.

In some embodiments, the subroutine is one of a plurality of subroutines to be accessed, and each subroutine of the plurality of subroutines to be accessed is encapsulated and packaged respectively.

In some embodiments, the access control method further comprises: if the judgment result is no match, denying the main program to access the subroutine, keeping an error log, and prompting the user information indicating that the access request is an illegal request and/or information requesting the user to return to a previous page.

According to other embodiments of the present disclosure, there is provided a program deployment method, comprising: configuring an attribute of a subroutine according to relevant information of a service corresponding to the subroutine, wherein the attribute of the subroutine is configured to judge whether a user who initiates an access request through a main program is allowed to access the subroutine; and encapsulating the subroutine with the attribute as a label.

In some embodiments, the attribute of the subroutine comprises access path information of one or more associated pages of the subroutine.

In some embodiments, the access path information comprises address information of each associated pages of the one or more associated pages, and the relevant information comprises a requirement of the service, and configuring an attribute of the subroutine according to relevant information of a service corresponding to the subroutine comprises: determining an association relationship between the subroutine and the one or more associated pages according to the requirement of the service.

In some embodiments, the one or more associated pages comprise a plurality of associated pages, the access path information comprises routing information between each associated page of the plurality of associated pages, the service comprises a plurality of sub-services, and the relevant information comprises a processing order of the plurality of sub-services, and the routing information between each associated page of the plurality of associated pages is determined according to the processing order of the sub-services.

In some embodiments, the program deployment method further comprises: determining whether the subroutine has an association relationship with at least one main program according to a requirement of the service corresponding to the subroutine and a requirement of a service corresponding to the at least one main program, wherein the association relationship is configured to judge whether the main program initiating the access request is allowed to access the subroutine.

According to still other embodiments of the present disclosure, there is provided an access control device, comprising: a receiving unit for receiving an access request for a subroutine initiated by a user through a main program; a judgment unit for determining a judgment result according to whether a first attribute of the access request matches a second attribute of the subroutine, wherein the second attribute is determined according to relevant information of a service corresponding to the subroutine; a control unit for allowing the user to access the subroutine in response to the judgment result being a match.

According to further embodiments of the present disclosure, there is provided a program deployment device, comprising: a configuration unit for configuring an attribute of a subroutine according to relevant information of a service corresponding to the subroutine, wherein the attribute of the subroutine is configured to judge whether a user who initiates an access request through a main program is allowed to access the subroutine; an encapsulation unit for encapsulating the subroutine with the attribute as a label.

According to still further embodiments of the present disclosure, there is provided an electronic device, comprising: a memory; and a processor coupled to the memory, the processor being configured to execute the access control method or the program deployment method in any embodiment of the present disclosure based on instructions stored in the memory device.

According to still further embodiments of the present disclosure, there is provided a computer-readable storage medium on which a computer program is stored, which, when executed by a processor, implements the access control method or the program deployment method in any embodiment of the present disclosure.

Other features and advantages of the present disclosure will become clear through detailed descriptions of the illustrative embodiments of the present disclosure with reference to the following accompanying drawings.

### BRIEF DESCRIPTION OF THE DRAWINGS

Drawings explained here are used to provide further understanding of the present disclosure, which constitute a portion of the present application. The schematic embodiments and description of the present disclosure are only used for explaining the present disclosure, and do not constitute improper delimitations of the present disclosure. In the attached drawings:

FIG. 1 shows a flow diagram of an access control method according to some embodiments of the present disclosure;

FIG. 2 shows a schematic diagram of access path information of a subroutine according to some embodiments of the present disclosure;

FIG. 3 shows a flow diagram of a program deployment method according to some embodiments of the present disclosure;

FIGS. 4a to 4e show flow diagrams of a program deployment method and an access control method according to some embodiments of the present disclosure;

FIGS. 5a-5c show schematic diagrams of program deployment pages according to some embodiments of the present disclosure;

FIG. 6 shows a block diagram of an access control device according to some embodiments of the present disclosure;

FIG. 7 shows a block diagram of a program deployment device according to some embodiments of the present disclosure;

FIG. 8 shows a block diagram of an electronic device according to some embodiments of the present disclosure;

FIG. 9 shows a block diagram of other embodiments of the electronic device of the present disclosure;

FIG. 10 shows a block diagram of still other embodiments of the electronic device of the present disclosure.

### DESCRIPTION OF THE INVENTION

The technical solutions in the embodiments of the present disclosure will be clearly and completely described below with reference to the accompanying drawings in the embodiments of the present disclosure. Obviously, the described embodiments are only a part of the embodiments of the present disclosure instead of all of them. The following descriptions on at least one exemplary embodiment are actually illustrative, and are in no way intended to set any limitation on the present disclosure and its application or utilization. All other embodiments that are obtainable to those skilled in the art based on the embodiments of the present disclosure without any creative effort are comprised in the protection scope of the present disclosure.

Unless otherwise illustrated, respective arrangements, mathematic expressions and values of the components and steps illustrated in these embodiments do not limit the scope of the present disclosure. Meanwhile, it shall be understood that in order to facilitate description, the respective parts shown in the drawings are not drawn in sizes according to actual proportional relations. Techniques, methods and devices that have already been known to ordinary skilled in the art may not be discussed here in details, but under suitable circumstances, the techniques, methods and devices shall be deemed as parts of the authorized description. In all examples shown and discussed herein, any specific values should be interpreted as illustrative only and not as a limitation. Therefore, other examples of the exemplary embodiments may have different values. It should be noted that similar numbers and letters indicate similar items in the following drawings, so once an item is defined in one drawing, it does not need to be further discussed in subsequent drawings.

As mentioned above, since a system package (i.e. program package, deployment package, etc.) may be a collection of a plurality of subroutines, the system package launched is likely to cause wrong access to a plurality of subroutines. In this way, users may enter subroutines that are beyond their permission from the main program, thus reducing the security of data.

In view of the above technical problem, the present disclosure intends to add attribute configuration to the subroutines at the code level, and add access flow judgment to ensure data security.

For example, for a plurality of subroutines launched based on the same system package, the technical solution of the present disclosure can achieve that in response to a main program accessing its dedicated subroutines, if a user wants to access the subroutine permission configured by a non-main program by modifying the access attribute, the access is directly denied, an error is reported, and the information is recorded and returned to the main program. If the number of times a user is rejected exceeds the threshold, the user can be directly added to the blacklist; the user can continue to initiate the access request only after the user applies for removal from the backlist and the application is approved. In this way, the access security of subroutines and data security are guaranteed.

The inventor of the present disclosure finds that there are the following problems in the above-mentioned related art: illegal access requests may occur during the use of subroutines, resulting in page access errors, which pose a great threat to the use process security and data security of the subroutines.

In view of this, the present disclosure proposes an access control technical solution, which can improve the use process security and data security of the subroutines.

The present disclosure provides a solution to the control of illegal requests in the case that a plurality of subroutines are deployed in the same system package. The technical solution of the present disclosure solves and optimizes practical problems based on the above scenarios and application technologies.

In some embodiments, on the one hand, in terms of access permission control of subroutines, based on the idea of authentication control, the service attribute of the subroutine is configured at the code level to protect the security request of the subroutine associated with a plurality of pages in one system. The technical solution of the present disclosure is not simply aimed at expanding scenarios and increasing the diversity of control methods, but also a deployment solution that integrates the code level and the service level. On the other hand, since a security solution need to be applicable to have use value, the technical solution of the present disclosure adds diversified security strategies to the practical security solution to increase security guarantee.

For example, the technical solution of the present disclosure can be realized by the following embodiments.

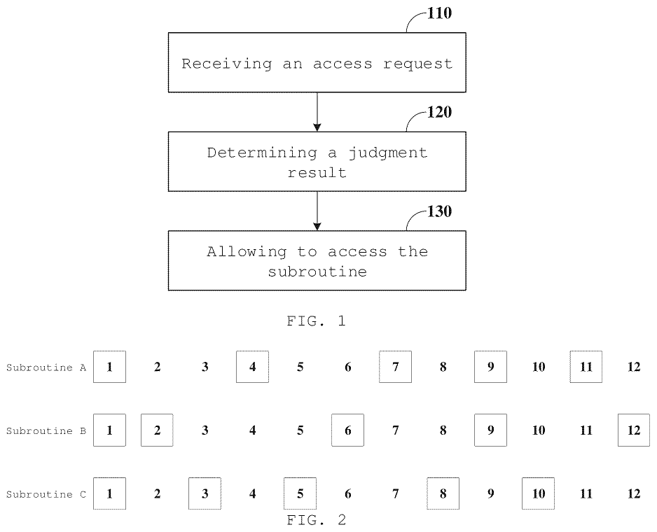

FIG. 1 shows a flow diagram of an access control method according to some embodiments of the present disclosure.

As shown in FIG. 1, in step 110, receiving an access request for a subroutine initiated by a user through a main program. For example, the subroutine has a pre-bound second attribute, comprising second access path information of one or more associated pages of the subroutine.

In some embodiments, the subroutine is one of a plurality of subroutines to be accessed, and each subroutine of the plurality of subroutines to be accessed is encapsulated and packaged respectively.

In some embodiments, the second attribute is determined according to the relevant information of the service corresponding to the subroutine.

For example, in the configuration stage of the subroutine, it is necessary to obtain a service requirement first, and then initially determine the purpose of the subroutine according to the service requirement. This is mainly to determine which service scenarios the subroutine involves, so as to determine which program pages the subroutine needs to be associated with (that is, the associated pages of the subroutine).

For example, based on the application scenario where there are a plurality of subroutines in a main program, the user needs two service functions provided by at least two subroutines—real name authentication function and device binding function. The associated pages of these two service functions are partly the same and partly different.

In the above embodiment, although both subroutines need to load the personal information of the customer, the subsequent operations of the two subroutines are different after loading the personal information of the customer, resulting in different associated pages corresponding to the subsequent operations. According to the different scenarios of the service requirement corresponding to the subroutine, the scenario that should be implemented in this configuration stage can be defined. In order to avoid the page switch error between two subroutines, it is necessary to pre-configure the associated page of each subroutine, so as to improve the security of page access.

In step 120, a judgment result is determined according to whether a first attribute of the access request matches a second attribute of the subroutine. The second attribute is determined according to the relevant information of the service corresponding to the subroutine.

In some embodiments, the first attribute comprises first access path information of one or more access pages of the access request, and the second attribute comprises second access path information of one or more associated pages of the subroutine.

For example, according to the obtained service requirement, the associated page involved in the subroutine can be filtered out; according to the actual service logic, the routing information between different pages is defined. In the case that the service requirement comprises a real-name authentication requirement, according to the processing logic of the service, the association relationship (comprising routing information) between pages is determined based on the product flow of the product prototype design. For example, the service comprises a plurality of sub-services, and the processing logic comprises the processing order of the plurality of sub-services.

In this way, the user's authority can be limited in the association relationship, thus completing the determination of the service processing flow of the subroutine.

In some embodiments, the subroutine is encapsulated with the second attribute as a label. For example, the modular configuration of the subroutine can be carried out in advance, and the attribute of the subroutine is used as a label to perform modular configuration and encapsulation at the code level according to the configuration order.

For example, the subroutine is encapsulated according to the following steps: determining one or more associated pages of the subroutine according to the requirement of the service corresponding to the subroutine; configuring the second attribute for the subroutine according to the one or more associated pages; encapsulating the subroutine with the second attribute as a label.

For example, the access path information comprises address information of a page and routing information between a plurality of pages. The embodiments in FIG. 2 can be used to bind the access path information with the subroutine to realize the encapsulation of the subroutine.

FIG. 2 shows a schematic diagram of access path information of a subroutine according to some embodiments of the present disclosure.

As shown in FIG. 2, the developer of subroutines develops three subroutines—subroutine A, subroutine B and subroutine C, and these three subroutines comprise a total of 12 pages, which are represented by numbers 1-12. Now it is necessary to launch these three subroutines on the open platform.

In some embodiments, the relevant information of the service comprises the requirement of the t service, and the association relationship between the subroutine and one or more associated pages is determined according to the requirement of the service; the service comprises a plurality of sub-services, and the relevant information comprises the processing order of the sub-services, and the routing information between each associated page of the plurality of associated pages is determined according to the processing order of the sub-services.

For example, the first access path information comprises address information of each access page of the one or more access pages, and the second access path information comprises address information of each associated pages of the one or more associated pages. The address information may comprise URL (Uniform Resource Locator) of each page, etc.

In some embodiments, one or more access pages comprise a plurality of access pages, and the first access path information comprises routing information between each access page of the plurality of access pages. One or more associated pages comprise a plurality of associated pages, and the second access path information comprises routing information between each associated page of the plurality of associated pages.

For example, in the case that the subroutine comprises one or more associated pages, the second access path information comprises address information of each associated page (such as URL of each associated page, etc.); in the case that the subroutine comprises a plurality of associated pages, the second access path information also comprises routing information between the associated pages, that is, the order of accessing the associated pages.

In some embodiments, the case where a subroutine comprises a plurality of associated pages is shown in FIG. 2.

FIG. 2 shows the encapsulation results of associated pages of the three subroutines through a modular configuration flow.

For example, according to the service requirement of subroutine A, it is determined that the associated pages of the subroutine A comprise page 1, page 4, page 7, page 9 and page 11, and then the address information of these pages can be determined; according to the processing logic of the service of the subroutine A, the page access order corresponding to the subroutine A, namely routing information, is determined to be page 1, page 4, page 7, page 9 and page 11. The second access path information of the subroutine A may comprise the respective URLs of pages 1, 4, 7, 9 and 11, and the access order among pages 1, 4, 7, 9 and 11.

For example, according to the service requirements of subroutine B, it is determined that the associated pages of the subroutine B comprise page 1, page 2, page 6, page 9 and page 12, and then the address information of these pages can be determined; according to the processing logic of the service of the subroutine B, the corresponding page access order, namely routing information, is determined to be page 1, page 2, page 6, page 9 and page 12.

For example, according to the service requirements of subroutine C, it is determined that the associated pages of the subroutine C comprise page 1, page 3, page 5, page 8 and page 10, and then the address information of these pages can be determined; according to the processing logic of the service of the subroutine C, the corresponding page access order, namely routing information, is determined to be page 1, page 3, page 5, page 8 and page 10.

In some embodiments, subroutines A, B and C are all subroutines to be accessed and can be encapsulated and packaged respectively. For example, the above-mentioned three sub-programs can be packaged into three sub-packages and launched in the system.

In the above embodiment, because the service corresponding to each subroutine is different, the logical relationship (such as routing information) of each subroutine's associated pages is also different, so for the logical relationship corresponding to the subroutine, the address information and routing information are associated and pre-configured at the code level. In this way, the modular configuration of subroutines can be completed according to the service requirements and configuration flow, which is configured to control users' access to subroutines, thus improving security.

In some embodiments, the judgment result is determined according to whether the subroutine is an associated subroutine of the main program. For example, the association relationship between the main program and the associated subroutine is determined according to the requirement of the service corresponding to the main program and the service corresponding to the associated subroutine.

For example, after the subroutine is successfully launched, it is necessary to associate the main program with the subroutine if the main program wants to call the subroutine it wants to use. The related attribute of the main program can comprise: identification information (such as APPID), key, access path information, etc. The APPID of the main program and the APPID of the subroutine can be used to establish the association between the main program and the subroutine.

In some embodiments, the first attribute comprises the key of the access request, and the second attribute comprises the key of the subroutine.

For example, the authentication method can be used to confirm the correctness of the key in the access request, so as to ensure that the access request of the main program is a legal request in the case that the main program sends the access request.

In some embodiments, the first attribute comprises the key of the access request and first access path information of one or more access pages of the access request, and the second attribute comprises the key of the subroutine and the second access path information of one or more associated pages of the subroutine. It is judged whether the subroutine is an associated subroutine of the main program; in the case that the subroutine is an associated subroutine of the main program, it is judged whether the key of the access request matches the key of the subroutine; in the case that the key of the access request matches the key of the subroutine, the judgment result is determined according to whether the first access path information matches the second access path information.

For example, whether the access request of the main program is legal can be judged through a plurality of judgment conditions. The address information and routing information can be used as the main judgment basis.

For example, first, it is determined whether the main program making the access request has an association relationship with the target subroutine; if yes, it is judged whether the keys of the two match; if it is a match, it is judged whether the address information and the routing information match.

In the above embodiments, it is ensured that even a main program user who has permission to access a subroutine cannot access the associated pages of other subroutines arbitrarily, thus improving the security.

For example, the user accesses the subroutine A (whose associated pages are page 1, page 4, page 7, page 9 and page 11) through the main program, and passes the above association relationship judgment, key matching judgment and address information matching judgment, indicating that the main program is a legal main program. However, if the user requests to access a page other than pages 1, 4, 7, 9 and 11 by modifying the path or other illegal means through the main program, such as page 2, the routing information matching judgment cannot be passed. In this case, the access request initiated by the main program is judged to be illegal, and is directly denied by the system. Therefore, data security and access security are guaranteed.

After the attribute matching judgment is made, the access control can be continued through the remaining steps in FIG. 1.

In step 130, in response to the judgment result being a match, the user is allowed to access the subroutine.

In some embodiments, the access control method further comprises: in response to the judgment result being a mismatch, denying the main program to access the subroutine, keeping an error log, and prompting the user information indicating that the access request is an illegal request and/or information requesting the user to return to a previous page.

For example, in response to the access request initiated by the user through the main program being a legal request, the access request passes the authority judgment; in response to the access request initiated by the user through the main program being an illegal request, the access is denied. According to the judgment result, a log can be generated and kept for audit purpose, thus improving security.

In some embodiments, in the system processing stage, access requests that pass the authority judgment can be allowed to perform a logical access, and traces are recorded to complete the whole request link.

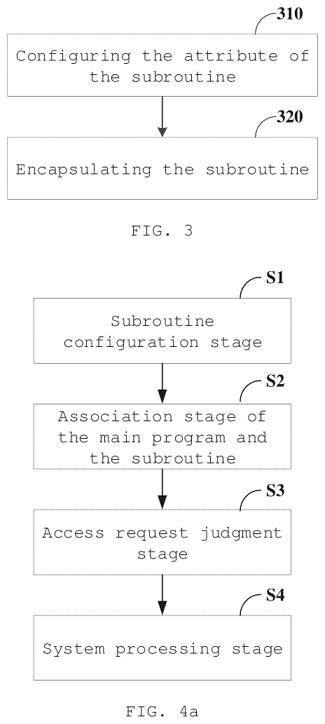

FIG. 3 shows a flow diagram of a program deployment method according to some embodiments of the present disclosure.

As shown in FIG. 3, in step 310, the attribute of the subroutine is configured according to the relevant information of the service corresponding to the subroutine. The attribute of the subroutine is configured to judge whether the user who initiates the access request through the main program is allowed to access the subroutine.

In some embodiments, the attribute of the subroutine comprises access path information of one or more associated pages of the subroutine.

In some embodiments, the access path information comprises address information of each associated pages of the one or more associated pages, and the relevant information comprises the requirement of the service. According to the requirement of the service, the association relationship between the subroutine and the one or more associated pages is determined.

In some embodiments, one or more associated pages comprise a plurality of associated pages, the access path information comprises routing information between each associated page of the plurality of associated pages, and the relevant information comprises the processing logic of the service. The access path information is determined according to the processing logic of the service.

In some embodiments, it is determined whether the subroutine has an association relationship with at least one main program according to the requirement of the service corresponding to the subroutine and the requirement of the service corresponding to the at least one main program. The association relationship is configured to judge whether the main program that initiates the access request is allowed to access the subroutine.

In step 320, the subroutine is encapsulated with the attribute as a label.

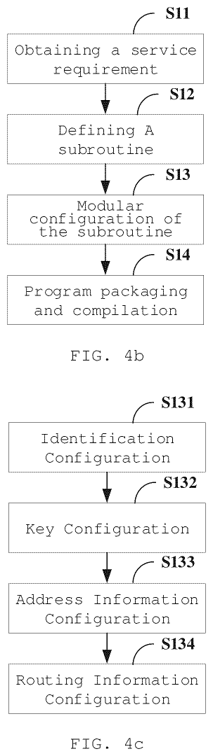

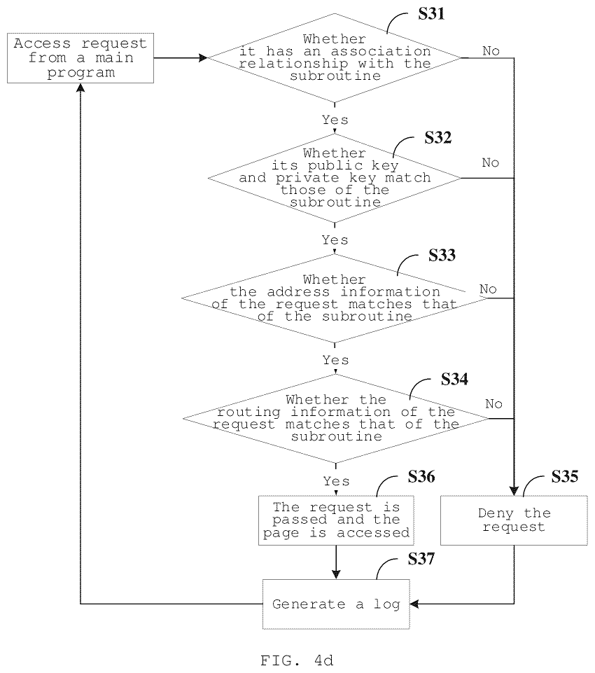

FIGS. 4a to 4e illustrate flow diagrams of a program deployment method and an access control method according to some embodiments of the present disclosure.

As shown in FIG. 4a, in step S1, the relevant processing of the subroutine configuration stage is performed, that is, the configuration initialization is completed.

For example, the attributes of the subroutines can be configured at the code level, and Appid, key, address information and routing information can be initialized. In this way, the associated pages of each subroutine can be logically isolated in advance by configuring the attributes, thus improving the security of access.

In step S2, the relevant processing of the association stage between the main program and the subroutine is performed.

For example, after the configuration initialization is completed, the subroutine is launched on the open platform according to the attribute of the subroutine; according to the service authority of the main program in the actual service situation, the main program is associated with the related subroutine to establish the association relationship as the judgment basis of the access request judgment stage.

The main tasks of the association stage between the main program and the subroutine comprise: after the subroutine is successfully launched, it is necessary to associate the main program with the subroutine if the main program wants to call up the subroutine it wants to use. The related attribute of the main program may comprise: identification information (such as APPID), key, access path information, etc. The APPID of the main program and the APPID of the subroutine can be used to establish the relationship between them.

In step S3, the relevant processing in the access request judgment stage is performed.

For example, the system judges whether the access page corresponding to the access request initiated by the user through the main program is a page outside the logical isolation configured in the configuration initialization stage according to the pre-configured attributes such as the association relationship between the main program and the subroutine, address information and routing information.

In this way, through the verification of secure access, it can be ensured that the access request is a legal request, and if it is illegal, it can be directly denied, thus improving security.

The main task of the access request judgment stage is to judge whether the access request of the main program is legal through a plurality of judgment conditions. Address information and routing information can be used as the main judgment basis.

In step S4, relevant processing in the system processing stage is performed. The main task of this stage is to realize the logical access of the access request that passes the verification, and record the traces to complete the whole request link.

In the above embodiment, not only the authentication problem of subroutine access is solved, but also the problem of illegal page access of a plurality of subroutines in the same system package is solved. Through the attribute configuration of subroutines, the subroutines developed by developers can be logically isolated at the code level; if there is an illegal intrusion access from outside, a blacklist rule is set to ensure the access security and data security of the micro-application itself.

As shown in FIG. 4b, step S1 can be realized through steps S11 to S14.

In step S11, a service requirement is obtained, and the purpose of the subroutine is initially determined according to the service requirement. For example, this step is mainly to determine which service scenario is involved in the subroutine, which program page is associated with the subroutine, and so on.

For example, there are many subroutine items in a main program, and users need the functions of two subroutines—real name authentication and device binding. The pages of these two functions are partly the same and partly different.

Although both subroutines need to load the customer's personal information, the subsequent operations of the two subroutines are different, resulting in different associated pages. According to the different scenarios of a service requirement corresponding to a subroutine, the scenario that should be implemented in this configuration stage can be defined. In order to avoid the page switch error between two subroutines, it is necessary to configure the associated pages of the subroutine, so as to improve the security of page access.

In step S12, a subroutine is defined. According to the result obtained of S11, a page involved in the subroutine is filtered out, and the association relationship between different pages is defined according to the actual service logic.

For example, in the case that a service requirement comprises a real-name authentication requirement, according to the processing logic of the service, the association relationship (comprising routing information) between pages is determined according to the product flow of the product prototype design. In this way, the user's authority can be limited in the association relationship, thus completing the determination of the service processing flow of the subroutine.

In step S13, modular configuration of the subroutine is performed. The attribute of the subroutine can be used as a label of the subroutine, and modular configuration and encapsulation are performed at the code level according to the configuration processing order (as shown in FIG. 4c).

In step S14, the subroutine is packaged and compiled. The encapsulated three subroutines can be packaged into three subroutines and launched on the system.

As shown in FIG. 4c, step S13 can be realized through steps S131~S134.

In step 131, the identification information of the subroutine can be configured. For example, the identification information may comprise information such as APPID that can uniquely identify the subroutine.

In step 132, the key of the subroutine can be configured. For example, a key may comprise a public key and a private key.

In step 133, the address information of the subroutine can be configured. For example, the address information may comprise the URLs of the associated pages, etc.

In step 134, the routing information of the subroutine can be configured.

For example, the developer of subroutines develops three subroutines—subroutine A, subroutine B and subroutine C, and these three subroutines comprises a total of 12 pages, which are represented by numbers 1-12. Now it is necessary to launch these three subroutines on the open platform.

According to the service requirement of subroutine A, it is determined that the associated pages of the subroutine A comprise page 1, page 4, page 7, page 9 and page 11, and then the address information of these pages can be determined; according to the processing logic of the service of the subroutine A, the page access order corresponding to the subroutine A, namely routing information, is determined to be page 1, page 4, page 7, page 9 and page 11.

For example, according to the a service requirement of subroutine B, it is determined that the associated pages of the subroutine B comprise page 1, page 2, page 6, page 9 and page 12, and then the address information of these pages can be determined; according to the processing logic of the service of the subroutine B, the page access order corresponding to the subroutine B, namely routing information, is determined to be page 1, page 2, page 6, page 9 and page 12.

For example, according to the a service requirement of subroutine C, it is determined that the associated pages of the subroutine C comprise page 1, page 3, page 5, page 8 and page 10, and then the address information of these pages can be determined; according to the processing logic of the service of the subroutine C, the page access order corresponding to the subroutine C, namely routing information, is determined to be page 1, page 3, page 5, page 8 and page 10.

In the above embodiments, because the services corresponding to each subroutine are different, the logical relationships (such as routing information) of each subroutine's associated pages are also different, so for the logical relationship corresponding to the subroutine, the address information and routing information are associated and pre-configured at the code level. In this way, the modular configuration of subroutines can be completed according to the service requirement and configuration flow, which is configured to control users' access to subroutines, thus improving security.

As shown in FIG. 4d, step S3 can be realized through steps S31 to S37.

In step 31, it is judged whether the main program making the access request has an association relationship with the target subroutine. If yes, step S32 is executed; otherwise, step S35 is executed.

In step S32, it is judged whether the public key and the private key of the subroutine match those of the access request. If yes, step S33 is executed; otherwise, step S35 is executed.

In step S33, it is judged whether the address information of the access request matches the address information of the subroutine. If yes, step S34 is executed; otherwise, step S35 is executed.

In step S34, it is judged whether the routing information of the access request matches the routing information of the subroutine. If yes, step S36 is executed; otherwise, step S35 is executed.

In step S35, the access request is denied.

In step S36, the access request is passed.

In step S37, according to the judgment result, a log is generated and kept for audit purpose.

In the above embodiment, it is ensured that even the main program user who has a permission to access to a certain subroutine cannot access the associated pages of other subroutines arbitrarily, thus improving the security.

For example, the user accesses the subroutine A (whose associated pages are page 1, page 4, page 7, page 9 and page 11) through the main program, and passes the above association relationship judgment, key matching judgment and address information matching judgment, indicating that the main program is a legitimate main program. However, if the user requests to access a page other than pages 1, 4, 7, 9 and 11 by modifying the path or other illegal means through the main program, such as page 2, the routing information matching judgment cannot be passed. In this case, the access request initiated by the main program is judged to be illegal, and is directly denied by the system. Therefore, data security and access security are guaranteed.

As shown in FIG. 4d, the main program obtains the front-end access request form the user; the subroutine judges whether the access request is legal or not; in the case that the access request is legal, the page corresponding to the access request is switched to in order to complete the switch of the access request; in the case that the access request is illegal, an Error alarm is given and the access is denied; it is judged that that the access request is an illegal access request, and the user is prompted to return to the previous page.

In the above embodiments, with regard to the data access security problem under the subroutine open platform, the data access security of the subroutine is ensured by configuring the attributes of the subroutine at the code level.

In some embodiments, the method for encapsulating associated pages of a subroutine comprises not only the encapsulation of individual pages, but also the encapsulation methods such as grouping in pairs or in triples, etc.

In the above embodiments, the access request that passes the verification is allowed to perform logical access, and traces are recorded to complete the whole request link; if the access request fails to pass the verification, the access request is judged as an illegal request, and the access is denied and an error log is kept to prevent data tampering.

In the above embodiments, not only the access authentication and other permissions are processed, but also the request legality of the subroutine is judged according to the address information and routing information. The judgment basis is pre-configured in the code layer, which makes the judgment conditions more accurate and practical, thus improving the security.

In the above embodiments, multiple levels of judgment conditions are configured to ensure the security and legality of data.

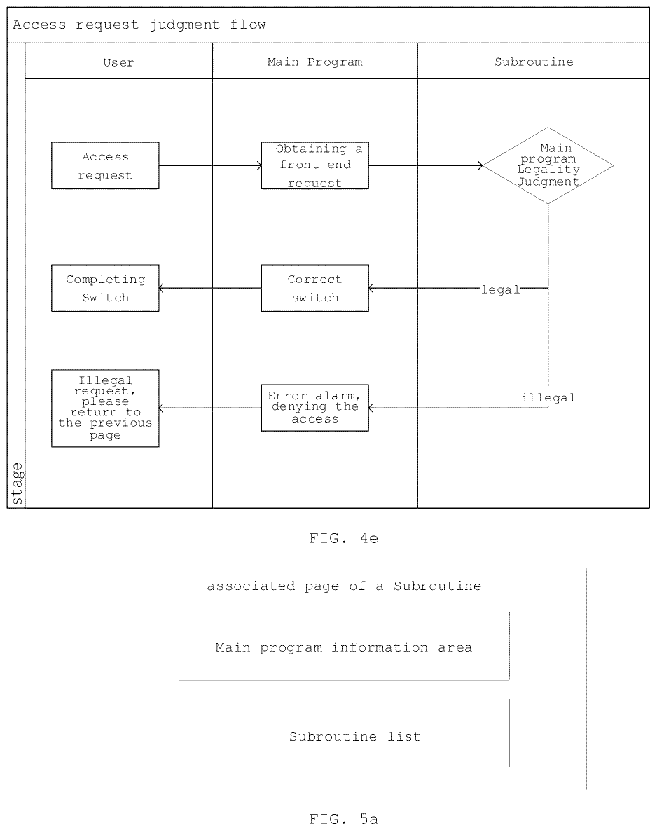

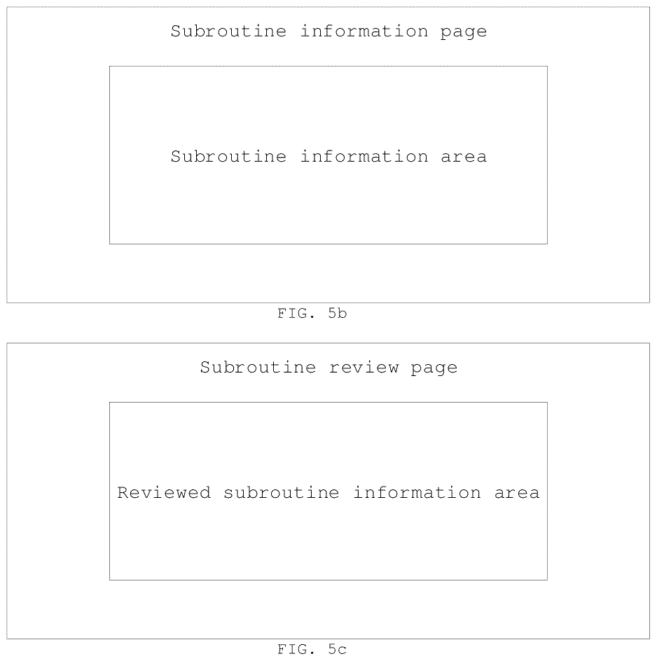

FIGS. 5a-5c show schematic diagrams of program deployment pages according to some embodiments of the present disclosure.

As shown in FIG. 5a, a association page of a subroutine comprises: a main program information area for displaying related information such as the name of the main program; a subroutine list, which is configured to display the name, ID and launching status of the subroutine to be associated.

For example, in response to the user selecting a subroutine in the subroutine list, a subroutine information page of the subroutine is switched to.

As shown in FIG. 5b, the subroutine information page comprises a subroutine information area, which is configured to display the name,, ID, key, access path and other attributes and related information of the subroutine.

For example, a subroutine review page is switched to, in response to a launching operation for the encapsulated subroutine.

As shown in FIG. 5c, the subroutine review page comprises: a reviewed subroutine information area, which is configured to display relevant information of the subroutine and the review information.

FIG. 6 shows a block diagram of an access control device according to some embodiments of the present disclosure.

As shown in FIG. 6, an access control device 6 comprises: a receiving unit 61 for receiving an access request for a subroutine initiated by a user through a main program; a judgment unit 62 for determining a judgment result according to whether a first attribute of the access request matches a second attribute of the subroutine, wherein the second attribute is determined according to relevant information of a service corresponding to the subroutine; a control unit 63 for allowing the user to access the subroutine if the judgment result is a match.

In some embodiments, the first attribute comprises first access path information of one or more access pages of the access request, and the second attribute comprises second access path information of one or more associated pages of the subroutine.

In some embodiments, the first access path information comprises address information of each access page of the one or more access pages, and the second access path information comprises address information of each associated pages of the one or more associated pages.

In some embodiments, the one or more access pages comprise a plurality of access pages, the first access path information comprises routing information between each access page of the plurality of access pages, and the one or more associated pages comprise a plurality of associated pages, and the second access path information comprises routing information between each associated page of the plurality of associated pages.

In some embodiments, the relevant information comprises a requirement of the service, and an association relationship between the subroutine and the one or more associated pages is determined according to the requirement of the service.

In some embodiments, the service comprises a plurality of sub-services, and the relevant information comprises a processing order of the plurality of sub-services, and the routing information between each associated page of the plurality of associated pages is determined according to the processing order of the sub-services.

In some embodiments, the judgment unit 62 determines the judgment result according to whether the subroutine is an associated subroutine of the main program.

In some embodiments, the association relationship between the main program and the associated subroutine is determined according to the requirement of the service corresponding to the main program and the service corresponding to the associated subroutine.

In some embodiments, the first attribute comprises a key of the access request, and the second attribute comprises a key of the subroutine.

In some embodiments, the first attribute comprises a key of the access request and first access path information of one or more access pages of the access request, and the second attribute comprises a key of the subroutine and second access path information of one or more associated pages of the subroutine. The judgment unit 62 judges whether the subroutine is an associated subroutine of the main program; judges whether the key of the access request matches the key of the subroutine in response to the subroutine being the associated subroutine of the main program; and in response to the key of the access request matching the key of the subroutine, determines the judgment result according to whether the first access path information matches the second access path information.

In some embodiments, the subroutine is encapsulated according to the following steps: determining one or more associated pages of the subroutine according to the requirement of the service corresponding to the subroutine; configuring the second attribute for the subroutine according to the one or more associated pages; encapsulating the subroutine with the second attribute as a label.

In some embodiments, the access control method further comprises: if the judgment result is a mismatch, denying the main program to access the subroutine, keeping an error log, and prompting the user that the access request is illegal and/or information requesting the user to return to a previous page.

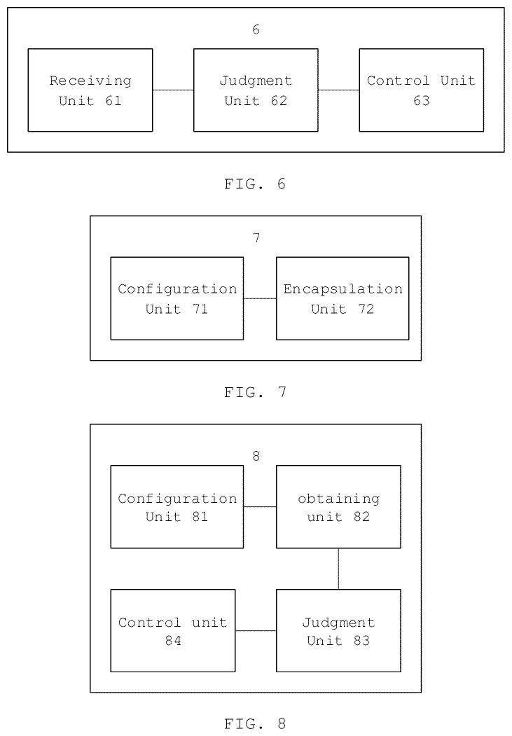

FIG. 7 shows a block diagram of a program deployment device according to some embodiments of the present disclosure.

As shown in FIG. 7, a program deployment device 7 comprises: a configuration unit 71 for configuring an attribute of a subroutine according to relevant information of a service corresponding to the subroutine, wherein the attribute of the subroutine is configured to judge whether a user who initiates an access request through a main program is allowed to access the subroutine; an encapsulation unit 72 for encapsulating the subroutine with the attribute as a label.

In some embodiments, the attribute of the subroutine comprises access path information of one or more associated pages of the subroutine.

In some embodiments, the access path information comprises the address information of each associated pages of the one or more associated pages, and the relevant information comprises a requirement of the service. The configuration unit 71 determines an association relationship between the subroutine and the one or more associated pages according to the requirement of the service.

In some embodiments, the one or more associated pages comprise a plurality of associated pages, the access path information comprises routing information between each associated page of the plurality of associated pages, the service comprises a plurality of sub-services, and the relevant information comprises a processing order of the plurality of sub-services, and the routing information between each associated page of the plurality of associated pages is determined according to the processing order. The configuration unit 71 determines the access path information according to the processing order of the sub-services.

In some embodiments, the configuration unit 71 determines whether the subroutine has an association relationship with at least one main program according to the requirement of the service corresponding to the subroutine and the requirement of the service corresponding to the at least one main program, and the association relationship is configured to judge whether the main program initiating the access request is allowed to access the subroutine.

FIG. 8 shows a block diagram of an electronic device according to some embodiments of the present disclosure.

As shown in FIG. 8, the electronic device 8 comprises a configuration unit 81, an obtaining unit 82, a judgment unit 83 and a control unit 84.

The configuration unit 81 defines and configures the attributes of subroutines at the code level according to the service requirements. For example, it can initialize APPID, key, address information and routing information, and logically isolate the pages required by the subroutine through configuration to complete the configuration function.

The obtaining unit 82 obtains the attribute of the access request, comprising APPID, key, address information, routing information, etc., as the judgment basis of the judgment unit.

The judgment unit 83 takes the data acquired by the obtaining unit 82 as the judgment basis, and performs matching and judgment when the obtaining unit 82 transmits the acquired data. For example, it can judge whether the access request is legal or not according to the judgment flow, and transmit the result to the control unit 84.

After acquiring the judgment result, the control unit 84 realizes the logical access of the access request that passes the verification, records the traces to complete the whole request link; if the access request fails to pass the verification and is judged as an illegal request, the access is denied and the error log is kept.

In the above embodiment, the access security and data security between multiple pages of subroutines of the same system package are guaranteed.

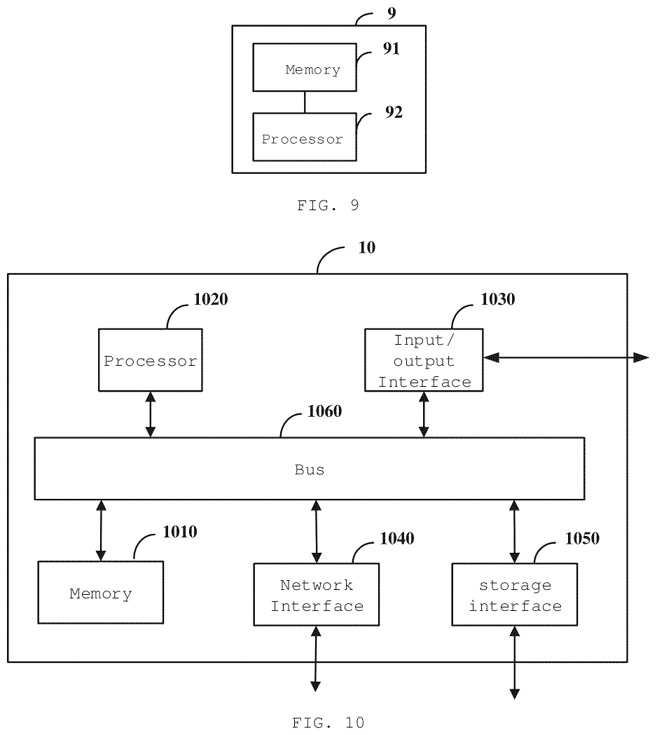

FIG. 9 shows a block diagram of other embodiments of the electronic device of the present disclosure.

As shown in FIG. 9, the electronic device 9 of this embodiment comprises a memory 91 and a processor 92 coupled to the memory 91, and the processor 92 is configured to execute the access control method or the program deployment method in any embodiment of the present disclosure based on instructions stored in the memory 91.

The memory 91 may comprise, for example, a system memory, a fixed nonvolatile storage medium, and the like. The system memory stores, for example, an operating system, application programs, a Boot Loader, a database and other programs.

FIG. 10 shows a block diagram of still other embodiments of the electronic device of the present disclosure.

As shown in FIG. 10, the electronic device 10 of this embodiment comprises a memory 1010 and a processor 1020 coupled to the memory 1010, and the processor 1020 is configured to execute the access control method or the program deployment method in any of the aforementioned embodiments based on instructions stored in the memory 1010.

The memory 1010 may comprise, for example, a system memory, a fixed nonvolatile storage medium, and the like. The system memory stores, for example, an operating system, an application program, a Boot Loader and other programs.

The electronic device 10 may also comprise an input/output interface 1030, a network interface 1040, a storage interface 1050, and the like. These interfaces 1030, 1040, and 1050, as well as the memory 1010 and the processor 1020, can be connected by a bus 1060, for example. The input/output interface 1030 provides a connection interface for input/output devices such as a display, a mouse, a keyboard, a touch screen, a microphone and a sound box. The network interface 1040 provides a connection interface for various networked devices. The storage interface 1050 provides a connection interface for external storage devices such as SD cards and USB flash drives.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Furthermore, the present disclosure may take the form of a computer program product implemented on one or more computer-usable non-transitory storage media (comprising but not limited to disk storage, CD-ROM, optical storage, etc.) that contain computer-usable program codes.

Heretofore, the embodiments of the present disclosure have been described in details. In order to avoid shielding of the concept of the present disclosure, some details commonly known in the art are not described. Based on the above description, those skilled in the art can fully understand how to carry out the technical solutions disclosed herein.

The method and system of the present disclosure may be implemented in many ways. For example, the method and system of the present disclosure can be implemented by software, hardware, firmware or any combination of software, hardware and firmware. The above sequence of steps used in the method is only for illustration, and the steps of the method of the present disclosure are not limited to the sequence specifically described above, unless otherwise specified. Furthermore, in some embodiments, the present disclosure can also be implemented as programs recorded in a recording medium, which comprise machine-readable instructions for implementing the method according to the present disclosure. Thus, the present disclosure also covers a recording medium storing a program for executing the method according to the present disclosure.

While some specific embodiments of the present disclosure have been described in details by way of examples, those skilled in the art should understand that the above examples are for illustrative purposes only and are not intended to limit the scope of the present disclosure. Those skilled in the art will appreciate that the above embodiments can be modified without departing from the scope and spirit of the present disclosure. The scope of the present disclosure is defined by the appended claims.

1. An access control method, comprising:
receiving an access request for a subroutine initiated by a user through a main program;
determining a judgment result according to whether a first attribute of the access request matches a second attribute of the subroutine, wherein the second attribute is determined according to relevant information of a service corresponding to the subroutine; and
allowing the user to access the subroutine in response to the judgment result being a match.

2. The access control method according to claim 1, wherein the first attribute comprises first access path information of one or more access pages of the access request, and the second attribute comprises second access path information of one or more associated pages.

3. The access control method according to claim 2, wherein the first access path information comprises address information of each access page of the one or more access pages, and the second access path information comprises address information of each associated pages of the one or more associated pages.

4. The access control method according to claim 2, wherein the one or more access pages comprise a plurality of access pages, the first access path information comprises routing information between each access page of the plurality of access pages, and the one or more associated pages comprise a plurality of associated pages, and the second access path information comprises routing information between each associated page of the plurality of associated pages.

5. The access control method according to claim 2, wherein the relevant information comprises a requirement of the service, and an association relationship between the subroutine and the one or more associated pages is determined according to the requirement of the service.

6. The access control method according to claim 4, wherein the service comprises a plurality of sub-services, and the relevant information comprises a processing order of the plurality of sub-services, and the routing information between each associated page of the plurality of associated pages is determined according to the processing order of the sub-services.

7. The access control method according to claim 1, wherein the determining the judgment result comprises:
determining the judgment result according to whether the subroutine is an associated subroutine of the main program.

8. The access control method according to claim 7, wherein an association relationship between the main program and the associated subroutine is determined according to a requirement of a service corresponding to the main program and a requirement of a service corresponding to the associated subroutine.

9. The access control method according to claim 1, wherein the first attribute comprises a key of the access request, and the second attribute comprises a key of the subroutine.

10. The access control method according to claim 1, wherein the first attribute comprises a key of the access request and first access path information of one or more access pages of the access request, and the second attribute comprises a key of the subroutine and second access path information of one or more associated pages of the subroutine, and
the determining the judgment result comprises:
judging whether the subroutine is an associated subroutine of the main program;
judging whether the key of the access request matches the key of the subroutine, in response to the subroutine being the associated subroutine of the main program; and
determining, in response to the key of the access request matching the key of the subroutine, the judgment result according to whether the first access path information matches the second access path information.

11. The access control method according to claim 1, wherein the subroutine is encapsulated according to following steps:
determining one or more the associated pages of the subroutine according to a requirement of the service corresponding to the subroutine;
configuring the second attribute for the subroutine according to the one or more associated pages; and
encapsulating the subroutine with the second attribute as a label.

12. The access control method according to claim 1, wherein the subroutine is one of a plurality of subroutines to be accessed, and each subroutine of the plurality of subroutines to be accessed is encapsulated and packaged respectively.

13. The access control method according to according to claim 1, further comprising:
in the case that the judgment result is a mismatch, denying the main program to access the subroutine, keeping an error log, and prompting the user information indicating that the access request is an illegal request and/or information requesting the user to return to a previous page.

14. A program deployment method, comprising:
configuring an attribute of a subroutine according to relevant information of a service corresponding to the subroutine, wherein the attribute of the subroutine is configured to judge whether a user who initiates an access request through a main program is allowed to access the subroutine; and
encapsulating the subroutine with the attribute as a label.

15. The program deployment method according to claim 14, wherein the attribute of the subroutine comprises access path information of one or more associated pages of the subroutine.

16. The program deployment method according to claim 15, the access path information comprises address information of each associated pages of the one or more associated pages, and the relevant information comprises a requirement of the service, and

[symbol]

17. The program deployment method according to claim 15, wherein the one or more associated pages comprise a plurality of associated pages, the access path information comprises routing information between each associated page of the plurality of associated pages, the service comprises a plurality of sub-services, the relevant information comprises a processing order of the plurality of sub-services, and
the configuring the attribute of the subroutine according to the relevant information of the service corresponding to the subroutine comprises:
determining the access path information according to the processing order of the sub-services.

18. The program deployment method according to claim 14, further comprising:
determining whether the subroutine has an association relationship with at least one main program according to a requirement of the service corresponding to the subroutine and a requirement of a service corresponding to the at least one main program, wherein the association relationship is configured to judge whether the main program initiating the access request is allowed to access the subroutine.

19. (canceled)

20. (canceled)

21. An electronic device comprising:
a memory; and
a processor coupled to the memory, the processor being configured to execute a program deployment method according to claim 14 or an assess control method, based on instructions stored in the memory device, comprising:
receiving an access request for a subroutine initiated by a user through a main program;
determining a judgment result according to whether a first attribute of the access request matches
a second attribute of the subroutine, wherein the second attribute is determined according to relevant information of a service corresponding to the subroutine; and
allowing the user to access the subroutine in response to the judgment result being a match.

22. A nonvolatile computer-readable storage medium on which a computer program is stored, which, when executed by a processor, implements a program deployment method according to claim 14 or an access control method, comprising:
receiving an access request for a subroutine initiated by a user through a main program;
determining a judgment result according to whether a first attribute of the access request matches
a second attribute of the subroutine, wherein the second attribute is determined according to relevant information of a service corresponding to the subroutine; and
allowing the user to access the subroutine in response to the judgment result being a match.
